(19) United States
(12) Patent Application Publication
(10) Pub. No.: US 2002/0076248 A1
(43) Pub. Date: Jun. 20, 2002

(54) METHOD OF FORMING METALLIC LUSTER IMAGE AND THERMAL TRANSFER RIBBON USED IN THE METHOD

(76) Inventors: YOSHIYUKI ASABE, IWATE-KEN (JP); YASUTOSHI INOUE, IWATE-KEN (JP); JUN SOGABE, OSAKA-FU (JP); YUUICHI MIYAKUSA, OSAKA-FU (JP)

Correspondence Address: BRINKS HOFER GILSON & LIONE, P.O. BOX 10395, CHICAGO, IL, 60610, US

(21) Appl. No.: 09/439,910

(22) Filed: Nov. 12, 1999

(30) Foreign Application Priority Data
Nov. 19, 1998 (JP) 10-329404

(51) Int. Cl. B41J 33/12; B41J 33/02; B41J 33/00; B41J 31/09

(52) U.S. Cl. 400/120.01

(57) ABSTRACT

The present invention provides a method of forming an image having both metallic luster and unevenness by thermal transfer. A ribbon A having a thermal transfer layer is used to selectively transfer at least once the thermal transfer layer onto an image receiving member to form a convex portion having a thickness of 3.0 μm or more, and a ribbon B having a thermal transfer layer containing a metallized layer is used to selectively transfer the thermal transfer layer containing the metallized layer onto the convex portion to form an image having both metallic luster and unevenness. The thickness of the thermal transfer layer of the ribbon B is 0.5 μm to 3.0 μm.

### BACKGROUND OF THE INVENTION

1. Field of the Invention

The present invention relates to a method of forming a metallic luster image by thermal transfer which is employed in word processors, facsimile apparatus, etc., and a thermal transfer ribbon used in the method. Particularly, the present invention relates to a method of an image having both metallic luster and unevenness, and a thermal transfer ribbon used in the method and comprising a thermal transfer layer having a metallized layer formed therein.

2. Description of the Related Art

In order to form an image having metallic luster by thermal transfer, a thermal transfer ribbon comprising a thermal transfer layer containing a metallized layer is conventionally used so that the thermal transfer layer is selectively transferred directly onto an image receiving member to form an image. However, this method cannot form an image having both metallic luster and unevenness.

### SUMMARY OF THE INVENTION

Accordingly, an object of the present invention is to provide a method of forming an image having both metallic luster and unevenness by thermal transfer, and a thermal transfer ribbon used in the method.

A method of forming a metallic luster image of the present invention comprises selectively transferring at least once a thermal transfer layer formed in a thermal transfer ribbon A onto an image receiving member to form a convex portion having a thickness of 3.0 μm or more, and then selectively transferring a thermal transfer layer containing a metallized layer, which is formed in a thermal transfer ribbon B, to form an image having both metallic luster and unevenness, wherein the thermal transfer layer of the thermal transfer ribbon B has a thickness of 0.5 μm to 3.0 μm,

The method of the present invention can obtain an image having patterned unevenness and a high degree of metallic luster.

In the method of forming a metallic luster image of the present invention, the thermal transfer layer of the thermal transfer ribbon A has a thickness of 3.0 μm or more.

Thus, the present invention can form an image having unevenness with a large difference in height within a short time to easily obtain a more attractive image having metallic luster.

A thermal transfer ribbon used as the thermal transfer ribbon B in the method of forming a metallic luster image of the present invention comprises a support and a thermal transfer layer formed thereon, wherein the thermal transfer layer comprises at least a release layer, a vaporization heat resistant layer, a metallized layer, a luster protecting layer, and an adhesive layer, which are laminated in turn on the substrate, wherein the vaporization heat resistant layer and the luster protecting layer are not thermally melted at 140° C. or have a melt viscosity of 10,000 poise or more at 140° C., and the total thickness of the two layers including the vaporization heat resistant layer and the luster protecting layer is 50% or more of the total thickness of the entire thermal transfer layer.

The use of the thermal transfer ribbon B permits formation of a metallic luster image having a high degree of luster.

### DESCRIPTION OF THE PREFERRED EMBODIMENT

As a ribbon A used in the present invention, a ribbon having a known structure and used for thermal transfer can be used. An example of such a ribbon comprises at least one thermal transfer layer provided on a support. A release layer may be used as the thermal transfer layer in contact with the support, and an adhesive layer may be used as the outermost thermal transfer layer.

The total thickness (including the thickness of the release layer when the ribbon A has the release layer) of the thermal transfer layer of the ribbon A is preferably 3.0 μm or more, more preferably 6.0 μm or more. Namely, the thickness of a convex portion formed by transferring the thermal transfer layer of the ribbon A is preferably 3.0 μm or more, more preferably 6.0 μm or more. When the thickness of the convex portion formed by transferring the thermal transfer layer of the ribbon A is less than the above range, it is difficult to obtain a feel of unevenness with metallic luster. When a convex portion having an intended thickness cannot be obtained by one time of thermal transfer because the thickness of the thermal transfer layer of the ribbon A is limited to less than 3.0 μm from the viewpoint of thermal transfer sensitivity, the intended thickness may be achieved by multiple times of overlap transfer of the thermal transfer layer of the ribbon A.

As materials for the thermal transfer layer of the ribbon A, materials generally used for a thermal transfer ribbon, such as wax, a thermoplastic resin, and various additives are appropriately used. A coloring agent may be contained together with these materials.

The ribbon B characteristic of the present invention will be described in detail below. The total thickness (including the thickness of the release layer when the ribbon B contains the release layer) of the thermal transfer layer of the ribbon B is preferably 0.5 μm to 3.0 μm. With a total thickness of less than 0.5 μm, the ribbon B tends to lack a masking ability. While with a total thickness of over 3.0 μm, it is difficult to obtain a feel of unevenness with metallic luster.

The ribbon B preferably comprises a support, and a thermal transfer layer formed thereon, wherein the thermal transfer layer preferably comprises a release layer, an evaporation heat resistant layer, a metallized layer, a luster protecting layer, and an adhesive layer, which are laminated in turn on the support.

As materials for the release layer, wax and a thermoplastic resin are appropriately used. However, from the viewpoint of maintenance of luster in thermal transfer, a material having high heat resistance, e.g., a material having a melting point or softening point of 100° C. or more, is preferred. The thickness of the release layer is preferably about 0.05 to 0.5 μm.

Preferably, the evaporation heat resistant layer and the luster protecting layer are not melted at 140° C., or have a melt viscosity of 10,000 poise or more at 140° C. Both layers are layers composed of a thermoplastic resin (elastomer) as a main component. With a melt viscosity of less than 10,000 poise at 140° C., the thermal transfer layer which is thinned so as to exhibit a feel of unevenness, as described above, does not have sufficient heat resistance, and tends to exhibit no luster due to breakage of the layer. The total thickness of two layers including the evaporation heat resistant layer and the luster protecting layer is preferably 50% or more of the total thickness of the thermal transfer layer (including the release layer). With a total thickness of the layers of less than 50%, there is the same tendency that luster is not exhibited. Examples of the thermoplastic resin used in the present invention include butyral resins, polyethyleneimine resins, polyester resins, polyamide resins, methacrylate resins, acrylate resins, polyvinyl alcohols, ionomer resins, and the like.

From the viewpoint of thermal transfer properties, the thickness of each of the evaporation heat resistant layer and the luster protecting layer is preferably 0.1 to 1.0 μm. With a thickness of less than 0.1 μm, the mechanical strength of a layer cannot be exhibited, and luster tends to decrease. With a thickness of over 1.0 μm, a feel of unevenness tends to be lacking. The evaporation heat resistant layer may be colored to obtain images exhibiting metallic luster having various colors. As the coloring agent used for coloring, a dye is preferred from the viewpoint of transparency, but a pigment may be used in a highly dispersed state.

As a metal for the metallized layer, aluminum, zinc, tin, silver, gold, platinum, and the like can be preferably used. The metallized layer can be formed by a physical evaporation method or chemical evaporation method such as a vacuum deposition method, a sputtering method, an ion plating method, or the like. The thickness of the metallized layer is preferably 10 to 100 nm, more preferably 15 to 40 nm, from the viewpoint of achievement of a high degree of metallic luster.

The adhesive layer comprises an adhesive resin as a main component. Examples of the adhesive resin include polyester resins, polyamide resins, polyurethane resins, ethylene-vinyl acetate copolymers, rosin resins, terpene resins, phenolic resins, and the like. The softening point of the adhesive layer is preferably 50 to 120° C. from the viewpoint of thermal transfer properties. The adhesive layer may contain a small amount of particles or lubricant for preventing the occurrence of blocking and staining. The thickness of the adhesive layer is preferably 0.1 to 1.0 μm.

As the support for each of the ribbons A and B, various supports known as supports for conventional thermal transfer ribbons can be used without any limit. However, from the viewpoint of durability, heat transference and cost, a polyethylene terephthalate film having a thickness of 1 to 10 μm is preferred. From the viewpoint of mechanical strength in transfer, particularly a polyethylene terephthalate film having a thickness of 3 to 6 μm is preferred. Preferably, an anti-sticking layer is provided on the back (the side in contact with a thermal head) of the support.

The present invention uses the ribbon A to selectively transfer the thermal transfer layer of the ribbon A to form a convex portion on an image receiving member, and uses ribbon B to selectively transfer the thermal transfer layer containing the metallized layer on the convex portion. The thermal transfer layer containing the metallized layer of the ribbon B may be transferred onto only the convex portion formed on the image receiving member by using the ribbon A, or onto the convex portion and other portions. As the ribbon A, a single-color ribbon may be used, or a plurality of color ribbons may be used for overlap transfer.

### EXAMPLES

Although the present invention is described below with reference to examples, the present invention is not limited to these examples.

Example

The ribbon A was formed as follows.

A polyethylene terephthalate film of 2.5 μm in thickness comprising a silicone resin anti-sticking layer of 0.2 μm in thickness, which was provided on one side of the film, was used as a support, and the layers below were formed in turn on the side of the film, which was opposite to the anti-sticking layer.

Release layer coating solution

| Component | Parts by weight |
|---|---|
| Paraffin wax | 10 |
| (melting point 65° C., melting heat 210 mJ/mg) | |
| Toluene | 90 |
| Total | 100 |

This coating solution was coated on the support, and then dried to form a release layer having a thickness of 1.0 μm.

Heat-sensitive color ink layer coating solution

| Component | Parts by weight |
|---|---|
| Ethylene-vinyl acetate copolymer | 8 |
| (vinyl acetate content 19% by weight, melt flow rate | |
| 150) | |
| Carbon black | 2 |
| Toluene | 90 |
| Total | 100 |

This coating solution was coated on the release layer, and then dried to form a heat-sensitive color ink layer having a thickness of 3.5 μm.

As a result, the ribbon A comprising a thermal transfer layer having a total thickness of 4.5 μm was obtained.

The ribbon B was formed as follows.

A polyethylene terephthalate film of 4.5 μm in thickness comprising a silicone resin anti-sticking layer of 0.2 μm in thickness, which was provided on one side of the film, was used as a support, and the layers below were formed in turn on the side of the film, which was opposite to the anti-sticking layer.

Release layer coating solution

| Component | Parts by weight |
|---|---|
| Polyethylene wax (softening point 125° C.) | 9 |
| Ethylene-vinyl acetate copolymer | 1 |
| (softening point 60° C.) | |
| Toluene | 90 |
| Total | 100 |

This coating solution was coated on the support, and then dried to form a release layer having a thickness of 0.2 μm and a softening point of 121° C.

Evaporation heat resistant layer coating solution

| Component | Parts by weight |
|---|---|
| Acrylic resin (softening point 150° C.) | 8 |
| Valifast Yellow 4120 | 2 |
| (yellow dye produced by Orient Chemical Industries | |
| Ltd.) | |
| Methyl ethyl ketone | 90 |
| Total | 100 |

This coating solution was coated on the release layer, and then dried to form an evaporation heat resistant layer having a thickness of 0.5 μm.

Then, aluminum was deposited on the evaporation heat resistant layer by a vacuum deposition method to form an aluminum deposited layer having a thickness of 20 nm.

Luster protecting layer coating solution

| Component | Parts by weight |
|---|---|
| Acrylic resin (softening point 150° C.) | 10 |
| Methyl ethyl ketone | 90 |
| Total | 100 |

This coating solution was coated on the aluminum deposited layer, and then dried to form a luster protecting layer having a thickness of 0.5 μm.

Adhesive layer coating solution

| Component | Parts by weight |
|---|---|
| Phenolic resin (softening point 90° C.) | 9.5 |
| Silica (average particle size: 1.0 μm) | 0.5 |
| Isopropyl alcohol | 90 |
| Total | 100 |

This coating solution was coated on the luster protecting layer, and then dried to form an adhesive layer having a thickness of 0.5 μm.

As a result, the ribbon B comprising a thermal transfer layer having a total thickness of 1.72 μm was obtained.

The ribbons A and B were used for over-printing on plain paper using a thermal transfer printer (produced by Alps Electric Co., Ltd., MD1300) under the following printing conditions:

Printing conditions for ribbon A

Printing condition: Gray scale mode (one of the standard printing modes provided in the driver of the printer used, which was a printing mode with low energy.)

Image pattern: Check pattern (thickness of a convex portion: about 4.5 μm)

Printing conditions for ribbon B

Printing condition: Photocolor mode (one of the standard printing modes provided in the driver of the printer used, in which the ribbon B was set in a photocolor yellow cassette.)

Image pattern: A modified flag pattern composed of yellow solid-printed parts and unprinted parts, the area of the yellow parts being 20% of the entire area of the pattern, which was printed to cover the print region formed by the ribbon A.

The glossiness of the obtained print was measured by Digital Glossmeter GM-260 made by Murakamisikisai Gijutukenkyusho. The printed image had a glossiness of 500 and a high degree of metallic luster. In the printed image, the check pattern initially formed by using the ribbon A was obtained as unevenness in the image, thereby obtaining an intended image having a feel of patterned unevenness and a high degree of metallic luster.

The present invention can form an image having both metallic luster and unevenness by thermal transfer.

What is claimed is:

1. A method of forming a metallic luster image comprising selectively transferring at least once a thermal transfer layer formed in a thermal transfer ribbon A onto an image receiving member to form a convex portion having a thickness of 3.0 μm or more, and then selectively transferring a thermal transfer layer containing a metallized layer formed in a thermal transfer ribbon B to form an image having both metallic luster and unevenness, wherein the thermal transfer layer of the thermal transfer ribbon B has a thickness of 0.5 μm to 3.0 μm.

2. A method of forming a metallic luster image according to claim 1, wherein the thermal transfer layer of the thermal transfer ribbon A has a thickness of 3.0 μm or more.

3. A thermal transfer ribbon used as the thermal transfer ribbon B in a method of forming a metallic luster image according to claim 1, the ribbon comprising a support and a thermal transfer layer formed thereon, wherein the thermal transfer layer comprises at least a release layer, a vaporization heat resistant layer, a metallized layer, a luster protecting layer, and an adhesive layer, which are laminated in turn on the substrate, wherein the vaporization heat resistant layer and the luster protecting layer are not thermally melted at 140° C. or have a melt viscosity of 10,000 poise or more at 140° C., and the total thickness of the two layers including the vaporization heat resistant layer and the luster protecting layer is 50% or more of the total thickness of the entire thermal transfer layer.

4. A thermal transfer ribbon used as the thermal transfer ribbon B in a method of forming a metallic luster image according to claim 2, the ribbon comprising a support and a thermal transfer layer formed thereon, wherein the thermal transfer layer comprises at least a release layer, a vaporization heat resistant layer, a metallized layer, a luster protecting layer, and an adhesive layer, which are laminated in turn on the substrate, wherein the vaporization heat resistant layer and the luster protecting layer are not thermally melted at 140° C. or have a melt viscosity of 10,000 poise or more at 140° C., and the total thickness of the two layers including the vaporization heat resistant layer and the luster protecting layer is 50% or more of the total thickness of the entire thermal transfer layer.
